(19) United States
(12) Patent Application Publication
(10) Pub. No.: US 2021/0362443 A1
(43) Pub. Date: Nov. 25, 2021

(54) Method for Producing a Fiber Composite Component and Fiber Composite Component

(71) Applicant: Bayerische Motoren Werke Aktiengesellschaft, Muenchen (DE)

(72) Inventors: Jan BOTH, Muenchen (DE); Wolfgang GRUBER, Landshut (DE); Werner SCHMIDT, Unterschleissheim (DE)

(21) Appl. No.: 16/766,405

(22) PCT Filed: Sep. 26, 2018
(86) PCT No.: PCT/EP2018/076155

§ 371 Date: May 22, 2020

(30) Foreign Application Priority Data
Nov. 23, 2017 (DE) 10 2017 220 899.6

(51) Int. Cl. B29C 70/54; B29C 70/46; B29C 33/60; B29C 33/68; B29C 70/08; B29C 70/74

(52) U.S. Cl. CPC B29C 70/542; B29C 70/465; B29C 33/60; B29L 2031/3005; B29C 70/085; B29C 70/74; B29C 33/68

(57) ABSTRACT

A method produces a fiber composite component for a motor vehicle. The method provides a semifinished fiber composite blank, wherein the semifinished fiber composite blank includes reinforcing fibers and a matrix material. The semifinished fiber composite blank is arranged between a first membrane and a second membrane. The semifinished fiber composite blank is shaped into a fiber composite molding by pressing the semifinished fiber composite blank together with the first membrane and the second membrane via a pressing device, and the fiber composite molding is consolidated.

### BACKGROUND AND SUMMARY OF THE INVENTION

The present invention relates to a method for producing a fiber composite component, in particular a carbon component, for a motor vehicle. The invention furthermore relates to a fiber composite component, in particular a carbon component, for a motor vehicle.

Adhering to climate targets and conserving resources are driving factors in the development of motor vehicles. Central aspects here are a reduction in the emissions of internal combustion engines and a reduction in fuel consumption. To achieve these aims, a focus is placed not only on a constant further development of drive concepts but also on a reduction of an overall weight of the motor vehicle. One measure for reducing the weight of a motor vehicle is the use of alternative materials, such as for example fiber-reinforced plastics, in particular fiber composite components. Fiber composite components have particularly advantageous mechanical characteristics relative to their own weight and are increasingly used to replace sheet-metal components of motor vehicles, such as for example body panels, trim panels, instrument panels or the like.

Fiber composite components have the disadvantage that they can be produced only with very great effort and are thus relatively expensive. The production of fiber composite components which are subject to increased visual requirements, that is to say in particular fiber composite components which are arranged on the motor vehicle so as to be highly visible from the outside, is particularly complex and expensive.

To produce fiber composite components, many different methods are known, such as for example prepreg autoclave methods or RTM methods. A “prepreg” is to be understood to mean a fiber matrix semifinished part which has both reinforcement fibers, such as for example carbon fibers, glass fibers, aramid fibers or the like, and a matrix material, such as for example resin. In a prepreg autoclave method, a fiber strand, laid fabric, woven fabric, mesh or the like composed of reinforcement fibers is firstly provided and is impregnated with the matrix material. The prepreg that is formed in this way is, in a next method step, arranged within a pressure chamber, a so-called autoclave, and is possibly deformed under pressure and cured under pressure and temperature. As a result of an intense build-up of pressure and high temperatures within the pressure chamber, individual layers of a multi-layer preform are pressed together and cure. RTM stands for “Resin Transfer Molding” and is also referred to as transfer molding. In the RTM method, a preform composed of reinforcement fibers is placed into a transfer mold and, subsequently, matrix material is injected into the transfer mold under pressure and at elevated temperature. Here, the matrix material also penetrates into the preform. Under pressure and temperature, the component generated in this way cures.

In all methods, subsequent contour trimming is normally required in order to remove protruding fiber residues from the generated component in edge regions, and to bring said component into the final component shape. Commonly, in a further working step, form elements are arranged on the component and adhesively bonded to the latter. Such form elements may for example be in the form of eyelets, hooks, steps, clips or the like. This process is highly time-consuming and thus drives up the production costs of such fiber composite components. To enhance the appearance of a surface of the fiber composite component, a finishing treatment of the surface of the fiber composite component is often subsequently performed, for example lacquering in order to enhance the appearance of the surface. In this way, visual appearance and/or a durability of the surface, in particular with respect to media, UV rays and the like, can be improved. Such a finishing treatment also gives rise to additional costs of the fiber composite component.

Known methods for producing fiber composite components have the disadvantage in particular that they are expensive and relatively time-consuming. These methods are normally unsuitable for short cycle times of a flow manufacturing process. For this reason, these methods can become established in an industrial operation only with difficulty, and are not suitable, or at least exhibit only very limited suitability, for mass production.

It is therefore an object of the present invention to eliminate or at least substantially eliminate the above-described disadvantages in the case of a method for producing a fiber composite component, as well as the component itself, in particular a carbon component, for a motor vehicle. In particular, it is an object of the present invention to provide a method for producing a fiber composite component for a motor vehicle, and a fiber composite component for a motor vehicle, which, in a simple and inexpensive manner, ensure reduced manufacturing times and/or improved component surfaces in the case of fiber composite components.

According to a first aspect of the invention, the object is achieved by means of a method for producing a fiber composite component for a motor vehicle according to the claimed invention. According to a second aspect of the invention, the object is achieved by means of a fiber composite component for a motor vehicle according to the claimed invention. Here, features and details described in conjunction with the method according to the invention for producing a fiber composite component for a motor vehicle self-evidently also apply in conjunction with the fiber composite component according to the invention for a motor vehicle, and vice versa in each case, such that reciprocal reference is always or can always be made in respect of the disclosure relating to the individual aspects of the invention.

According to the first aspect of the invention, the object is achieved by means of a method for producing a fiber composite component for a motor vehicle. The method has the following steps:
providing a fiber composite semifinished part, wherein the fiber composite semifinished part has reinforcement fibers and a matrix material,
arranging the fiber composite semifinished part between a first membrane and a second membrane,
deforming the fiber composite semifinished part to form a fiber composite molding by pressing the fiber composite semifinished part together with the first membrane and the second membrane by means of a pressing device, and
consolidating the fiber composite molding to produce the fiber composite component.

The fiber composite component to be produced has reinforcement fibers and is preferably in the form of a carbon component. Such a fiber composite semifinished part thus has carbon fibers as reinforcement fibers. Alternatively or in addition, the fiber composite semifinished part may have aramid fibers and/or glass fibers or the like as reinforcement fibers. The fiber composite semifinished part is preferably of plate-like form and may for example have a rectangular, in particular square, oval, in particular round, or virtually any desired base surface. Furthermore, according to the invention, the fiber composite semifinished part has a curable matrix material. The matrix material can preferably be melted and/or plasticized such that the reinforcement fibers are not damaged in the process.

The provided fiber composite semifinished part is subsequently arranged between a first membrane and a second membrane. Here, the first membrane is preferably arranged horizontally or substantially horizontally, such that the fiber composite semifinished part is laid with its base surface on the first membrane. The first membrane may for example be laid on a mold lower half or on a die. The second membrane is then laid on the fiber composite semifinished part and thus the first membrane. In this way, an arrangement is formed which can also be referred to as sandwich or double-diaphragm arrangement. The first membrane and the second membrane are preferably tensioned or are at least arranged so as to be free from undulations and folds, in order to prevent damage to the surface of the fiber composite semifinished part during the further course of the method. Preferably, the membranes have a melting point higher than a melting point of a matrix material of the fiber composite semifinished part.

Subsequently, the fiber composite semifinished part is deformed by means of the pressing device, by pressing-together of the fiber composite semifinished part with the first membrane and the second membrane, to form the fiber composite molding. Here, a pressure is exerted on the second membrane for example by means of a punch or a mold upper half of the pressing device. In this way, the second membrane is pressed against the fiber composite semifinished part, the fiber composite semifinished part is pressed against the first membrane, and the first membrane is pressed against the die or mold lower half. The mold upper half and mold lower half together preferably form a negative shape of the fiber composite component to be produced. By means of the first membrane and the second membrane, shear stresses between the fiber composite semifinished part and the pressing device are prevented or reduced, such that the surface of the fiber composite semifinished part is not damaged, or is only minimally damaged, during the deformation process.

In a subsequent method step, the fiber composite molding is consolidated. The consolidation is preferably performed within the pressing device under the action of pressure and/or temperature, in particular by cooling. For this purpose, the pressing device may for example have a cooling device which is designed in particular for cooling the punch and/or die or mold upper half and/or mold lower half. The consolidated, in particular cured, fiber composite molding may already be the fiber composite component to be produced. Provision may be made according to the invention whereby, to produce the fiber composite component, protruding material, in particular at edge regions, of the fiber composite molding is severed, in particular cut off. In addition or alternatively, provision may be made whereby, to produce the fiber composite component, the fiber composite molding is, in a subsequent method step, subjected to a surface treatment, in particular a lacquering or coating process, for example for the purposes of increasing a UV resistance, a fluid resistance, a resistance to dirt or the like.

The method according to the invention for producing a fiber composite component for a motor vehicle has the advantage over conventional methods that, using simple means and in an inexpensive manner, it is possible to produce a fiber composite component, in particular a carbon component, which has a particular uniform surface and which is also particularly suitable for industrial further processing. Owing to the high levels of attainable surface quality, it is thus possible during the production of a fiber composite component to at least partially omit cumbersome reworking steps for the purposes of enhancing the quality or enhancing the appearance of the surface. By means of the method according to the invention, throughput times and costs for the production of fiber composite components can be reduced, such that the method can be used economically even in the context of mass production.

Preferably, the provided fiber composite semifinished part is provided as a woven fabric, wherein the matrix material has a thermoplastic material. The matrix material is preferably a thermoplastic material. The thermoplastic material may be introduced into the woven fabric for example by infiltration, impregnation or by means of a melt bath, preferably in interaction with a double calender. Preferably, the woven fabric is embedded into the thermoplastic material. In addition or alternatively, the thermoplastic material may be arranged as thermoplastic fibers in the woven fabric. Aside from the thermoplastic material, the fiber composite semifinished part preferably has no non-thermoplastic matrix material. Provision may be made according to the invention whereby the fiber composite semifinished part has a higher concentration of the thermoplastic material in at least one region than at other regions, in order, at these regions, to promote the attachment of additional thermoplastic material, in particular in a subsequent injection molding process. During the deformation, the fiber composite semifinished part is preferably warmed such that the thermoplastic material is melted or plasticized, in order to promote a deformation of the fiber composite semifinished part and ensure dimensional stability of the produced fiber composite component after the curing. A woven fabric with a thermoplastic material has the advantage that this can be processed easily and inexpensively to form the fiber composite component in the context of the method according to the invention. Thus, an applicability of the method according to the invention in an industrial mass production context is improved.

In a preferred refinement of the method according to the invention, provision may be made whereby a polycarbonate is used as thermoplastic material of the fiber composite semifinished part. Polycarbonate has the advantage that it is lightweight and available at low cost. Furthermore, polycarbonates can be easily melted and cured. Polycarbonates are preferred which, after curing, have a glassy appearance or are transparent, because these are particularly suitable for the purposes of embedding and for the purposes of visually enhancing reinforcement fibers, in particular carbon fibers.

It is preferable for the fiber composite semifinished part to be, prior to curing, warmed such that the thermoplastic material is plasticized. The warming of the thermoplastic material is performed preferably by warming of the fiber composite semifinished part during the deformation in the pressing tool. Preferably, the warming is performed already prior to the deformation in order to improve a deformability of the fiber composite semifinished part.

Preferably, the woven fabric is in the form of a plain weave or twill weave. Such woven fabrics exhibit a high level of cohesion and are particularly easy to store and handle. Such woven fabrics have a uniform structure which is not adversely affected, or is only marginally adversely affected, even during the deformation of the fiber composite semifinished part between the first membrane and the second membrane.

According to a preferred refinement of the invention, provision may be made, in a method, whereby the first membrane and/or second membrane has a release coating on a side facing toward the fiber composite semifinished part. Preferably, both membranes have a release coating of said type. A release coating is a functional coating which promotes a release of the membrane from the fiber composite component. Preferably, the release coating is selected so as to reduce a level of friction between membrane and fiber composite component. A release coating is preferred which, during the melting or plasticizing of a thermoplastic material, does not form a bond with the latter, so as not to adversely affect a surface quality of the fiber composite component produced. By means of a release coating, it is possible to produce fiber composite components with particularly uniform surfaces and with a particularly uniform woven fabric structure.

In a method, provision may be made according to the invention whereby a parting film is arranged between the first membrane and the fiber composite semifinished part and/or between the second membrane and the fiber composite semifinished part prior to the pressing-together process. A parting film is a film which can be used as an intermediate layer for reducing friction and for reducing adhesion forces. The parting film is preferably designed such that, during the melting or plasticizing of a thermoplastic material, said parting film does not form a bond with said material, so as not to adversely affect a surface quality of the fiber composite component produced. Preferably, the parting film has a melting point which lies above the melting point of the thermoplastic material. By means of a parting film of said type it is possible to produce fiber composite components with particularly uniform surfaces and with a particularly uniform woven fabric structure.

Preferably, a first membrane and/or second membrane is used which has an elastomer and/or a silicone or which is formed from an elastomer and/or silicone. Such membranes exhibit greater temperature resistance than the thermoplastic material and high deformability, such that they can easily adapt to a deformation of the fiber composite semifinished part.

It is furthermore preferable if, in a following method step, at least one form element is integrally injection-molded onto the fiber composite molding by means of an injection molding device. Here, it is preferable if the form element is integrally injection-molded at a region of the fiber composite molding which has a relatively high fraction of thermoplastic material. As a result of the integral injection molding, cumbersome adhesive bonding of form elements is rendered superfluous. Furthermore, the integral injection molding has the advantage that, in this way, it is possible to realize a cohesive connection between the form element and the fiber composite molding, which has particularly advantageous physical characteristics, such as for example reduced notch effects, high strength or the like.

According to a second aspect of the invention, the object is achieved by means of a fiber composite component, in particular a carbon component, for a motor vehicle. The fiber composite component is in particular in the form of a mirror cap, ventilation paneling, body paneling component or interior component, such as for example an instrument panel, for a motor vehicle. According to the invention, the fiber composite component is produced by means of a method according to the invention.

All of the advantages already described above with regard to a method according to the first aspect of the invention for producing a fiber composite component for a motor vehicle arise in the case of the fiber composite component according to the invention for a motor vehicle. Accordingly, the fiber composite component according to the invention has the advantage over conventional fiber composite components that it can be produced using simple means and inexpensively so as to have a particularly uniform surface and so as to also be particularly suitable for industrial further processing. Owing to the high levels of attainable surface quality, it is thus possible during the production of a fiber composite component to at least partially omit cumbersome reworking steps for the purposes of enhancing the quality or enhancing the appearance of the surface. The fiber composite component according to the invention requires relatively short throughput times for production, and in so doing entails relatively low costs. The fiber composite component can thus be produced economically even in the context of mass production.

A method according to the invention for producing a fiber composite component for a motor vehicle, and a fiber composite component according to the invention for a motor vehicle, will be discussed in more detail below on the basis of drawings.

### BRIEF DESCRIPTION OF THE DRAWINGS

FIG. 1 shows, in a side view, a provided fiber composite semifinished part.

FIG. 2 shows, in a side view, a fiber composite molding during the deformation and consolidation.

FIG. 3 shows, in a side view, a produced fiber composite molding.

FIG. 4 shows, in a side view, a produced fiber composite component.

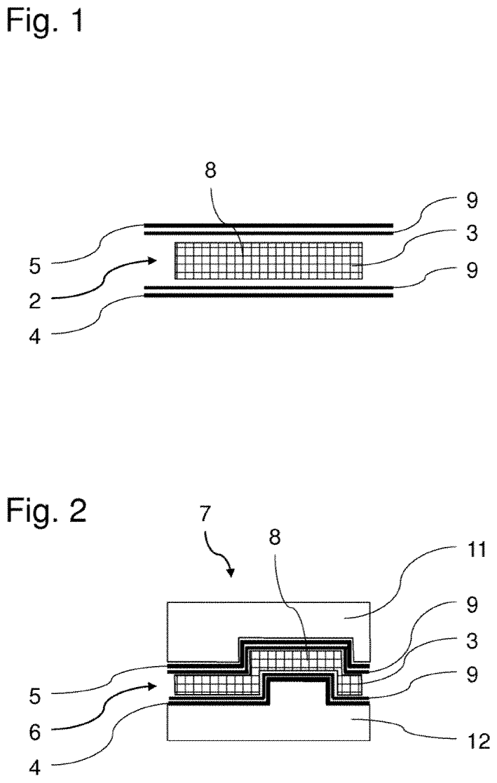

Elements with the same function and effect are in each case denoted by the same reference designations in FIGS. 1 to 4.

### DETAILED DESCRIPTION OF THE DRAWINGS

FIG. 1 schematically illustrates a provided fiber composite semifinished part 2 in a side view. The fiber composite semifinished part 2 has a woven fabric composed of reinforcement fibers 3 and of a matrix material 8, which has a thermoplastic material. The woven fabric composed of reinforcement fibers 3 is, in this example, embedded into the matrix material 8 or the thermoplastic material. The fiber composite semifinished part 2 is arranged between a first membrane 4 and a second membrane 5. In each case one parting film 9 for lowering a coefficient of friction is arranged between the first membrane 4 and the fiber composite semifinished part 2 and between the second membrane 5 and the fiber composite semifinished part 2.

In FIG. 2, the fiber composite semifinished part 2 from FIG. 1 has been deformed by means of a pressing tool 7 to form a fiber composite molding 6. For this purpose, the fiber composite semifinished part 2 arranged between the first membrane 4 and the second membrane 5 is arranged between a punch 11 and a die 12 of the pressing tool 7. As a result of the punch 11 and die 12 being moved together, and under the action of introduced heat, the matrix material 8 or the thermoplastic material is plasticized, and the fiber composite semifinished part 2 is deformed. As a result of the consolidation, the material matrix 8 or the plasticized thermoplastic material has solidified, such that the fiber composite molding 6 exhibits dimensional stability and can be removed from the pressing tool 7.

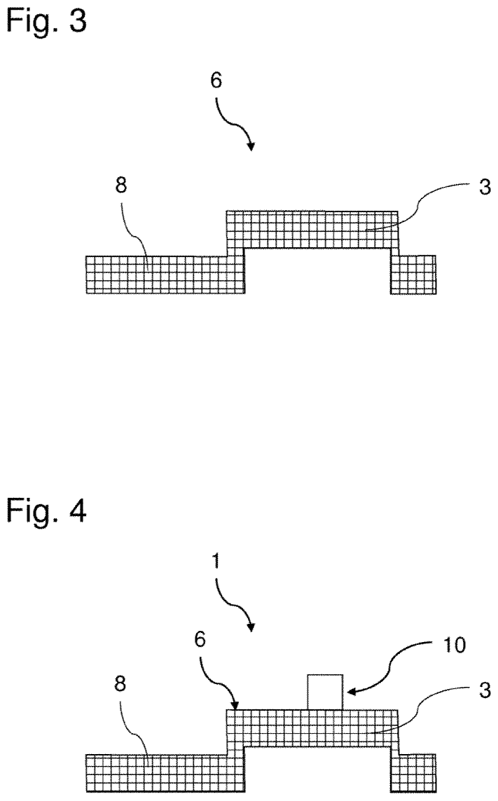

FIG. 3 schematically shows, in a side view, the produced fiber composite molding 6 removed from the pressing device 7. The first membrane 4, the second membrane 5 and the parting films 9 have detached from the fiber composite molding 6 and can be reused for the production of a further fiber composite molding 6. The reinforcement fibers 3 are furthermore present as a woven fabric, wherein the matrix material 8 or the thermoplastic material fills intermediate spaces of the woven fabric and holds the woven fabric together. In this example, the fiber composite molding 6 must be subjected to a further method step in order to produce the fiber composite component 1. Alternatively, provision may for example be made whereby the fiber composite molding 6 already forms the fiber composite component 1 to be produced.

FIG. 4 schematically shows a produced fiber composite component 1 in a side view. The fiber composite component 1 differs from the fiber composite molding 6 from FIG. 3 by a form element 10 which has been integrally injection-molded onto the fiber composite molding 6 for example by means of an injection molding process. The material of the form element 10 preferably corresponds to the matrix material 8 or to the thermoplastic material of the fiber composite semifinished part 2, such that an optimal connection between form element 10 and fiber composite molding 6 can be achieved.

### LIST OF REFERENCE DESIGNATIONS

1 Fiber composite component
2 Fiber composite semifinished part
3 Reinforcement fiber
4 First membrane
5 Second membrane
6 Fiber composite molding
7 Pressing device
8 Matrix material
9 Parting film
10 Form element
11 Punch
12 Die

1-10. (canceled)

11. A method for producing a fiber composite component for a motor vehicle, comprising:
providing a fiber composite semifinished part, wherein the fiber composite semifinished part has reinforcement fibers and a matrix material;
arranging the fiber composite semifinished part between a first membrane and a second membrane;
deforming the fiber composite semifinished part to form a fiber composite molding by pressing the fiber composite semifinished part together with the first membrane and the second membrane via a pressing device; and
consolidating the fiber composite molding to produce the fiber composite component.

12. The method according to claim 11, wherein
the provided fiber composite semifinished part is provided as a woven fabric, wherein the matrix material has a thermoplastic material.

13. The method according to claim 12, wherein
a polycarbonate is used as thermoplastic material of the fiber composite semifinished part.

14. The method according to claim 12, wherein
the fiber composite semifinished part is, prior to curing, warmed such that the thermoplastic material is plasticized.

15. The method according to claim 12, wherein
the woven fabric is in the form of a plain weave or twill weave.

16. The method according to claim 11, wherein
the first membrane and/or the second membrane has a release coating on a side facing toward the fiber composite semifinished part.

17. The method according to claim 11, wherein
a parting film is arranged between the first membrane and the fiber composite semifinished part and/or between the second membrane and the fiber composite semifinished part prior to being pressed-together.

18. The method according to claim 11, wherein
a first membrane and/or second membrane is used which has an elastomer and/or a silicone or which is formed from an elastomer and/or a silicone.

19. The method according to claim 11, further comprising:
in a following method step, at least one form element is integrally injection-molded onto the fiber composite molding via an injection molding device.

20. A fiber composite component produced according to the method of claim 11, wherein
the produced component is a motor vehicle component.

21. The fiber composite component according to claim 20, wherein
the component is a mirror cap, a ventilation paneling, a body paneling component or an interior component.
